(19) United States
(12) Patent Application Publication
(10) Pub. No.: US 2011/0153638 A1
(43) Pub. Date: Jun. 23, 2011

(54) CONTINUITY AND QUALITY OF ARTISTIC MEDIA COLLECTIONS

(75) Inventor: JAMES G. MCLEAN, FUQUAY-VARINA, NC (US)

(73) Assignee: INTERNATIONAL BUSINESS MACHINES CORPORATION, ARMONK, NY (US)

(21) Appl. No.: 12/640,684

(22) Filed: Dec. 17, 2009

(51) Int. Cl. G06F 17/30

(52) U.S. Cl. 707/769; 707/E17.014

(57) ABSTRACT

A computer-implemented method, system, and computer program product for generating a playlist is presented. A first media file, which is from an artistic media collection and has at least one feature described by first text data, is added to a playlist. An analytics resource is searched for at least one common feature associated with and shared by the first media file and a second media file from the artistic media collection. The common feature is identified by matching the first text data with second text data, about the second media file, in the analytics resource. In response to at least one common feature being identified for the first and second media files, the second media file is added to the playlist.

### BACKGROUND

The present disclosure relates to the field of computers, and specifically to media files played on computers. Still more particularly, the present disclosure relates to artistic media collections, such as playlists, of media files.

### BRIEF SUMMARY

A computer-implemented method, system, and computer program product for generating a playlist is presented. A first media file, which is from an artistic media collection and has at least one feature described by first text data, is added to a playlist. An analytics resource is searched for at least one common feature associated with and shared by the first media file and a second media file from the artistic media collection. The common feature is identified by matching the first text data with second text data, about the second media file, in the analytics resource. In response to at least one common feature being identified for the first and second media files, the second media file is added to the playlist.

### BRIEF DESCRIPTION OF THE SEVERAL VIEWS OF THE DRAWINGS

FIG. 1 depicts an exemplary computer that may be utilized by the presently disclosed method, system, and/or computer program product;

FIG. 2 illustrates an network in which the present disclosure may be implemented;

FIG. 3 depicts an exemplary user interface (UI) used by a user to set up a playlist of media files; and

FIG. 4 is a high-level flow-chart of one or more exemplary steps processed by a computer to dynamically create a playlist of media files based on commonality factors derived from analytics resources.

### DETAILED DESCRIPTION

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

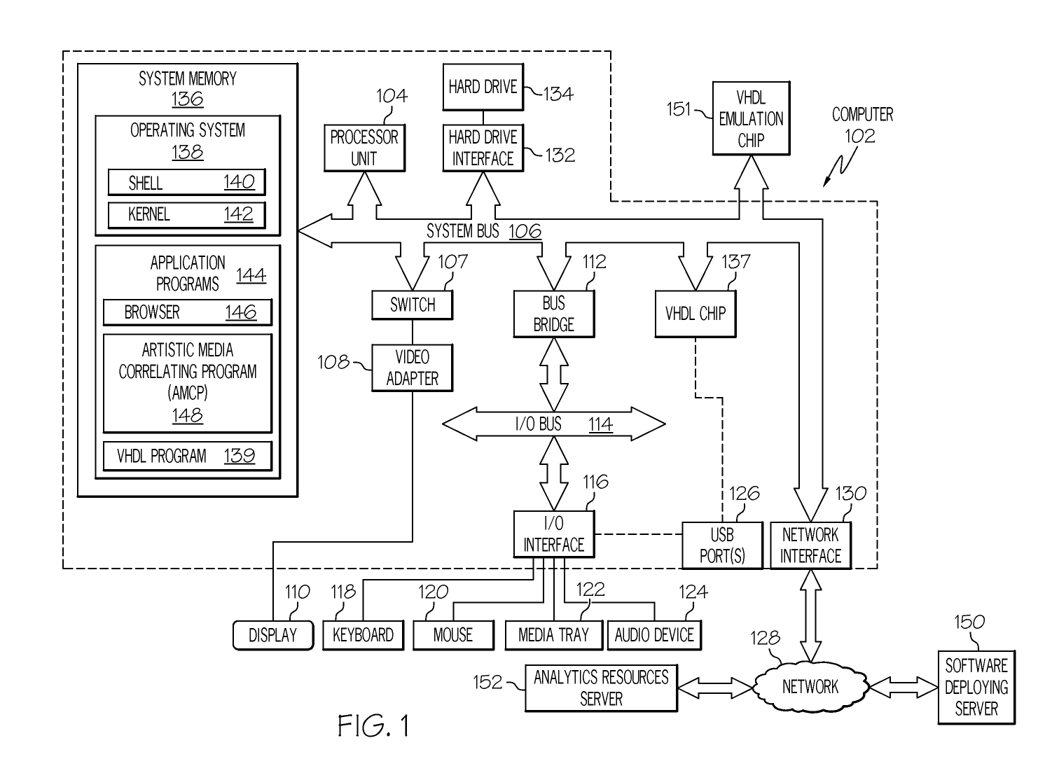

With reference now to the figures, and in particular to FIG. 1, there is depicted a block diagram of an exemplary computer 102, which may be utilized by the present disclosure. Note that some or all of the exemplary architecture, including both depicted hardware and software, shown for and within computer 102 may be utilized by software deploying server 150 and/or an analytics resources server 152.

Computer 102 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, preferably mechanical, that allows the display 110 to be coupled to the system bus 106, and thus to be functional only upon execution of instructions (e.g., artistic media correlating program—AMCP 148 described below) that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below), external USB port(s) 126. While the format of the ports connected to I/O interface 116 may be any known to those skilled in the art of computer architecture, in a preferred embodiment some or all of these ports are universal serial bus (USB) ports.

As depicted, computer 102 is able to communicate with a software deploying server 150, status notification server 152, and/or other status message implementing computer(s) 154 via network 128 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present disclosure will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other described computer systems.

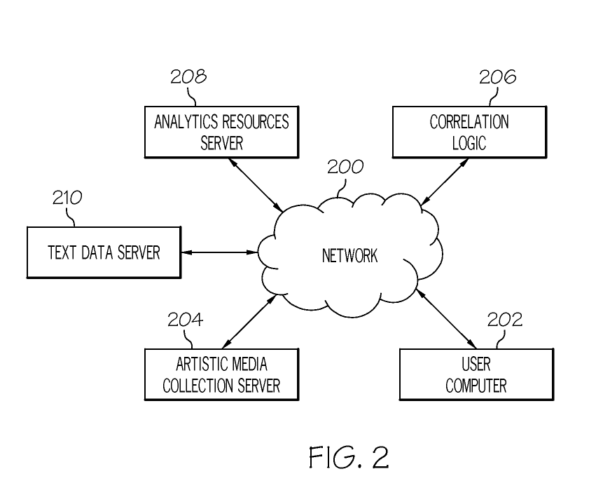

Application programs 144 in computer 102's system memory (as well as software deploying server 150's system memory) also include an artistic media correlating program (AMCP) 148. AMCP 148 includes code for implementing the processes described below, including those described in FIGS. 2-4. In one embodiment, computer 102 is able to download AMCP 148 from software deploying server 150, including in an on-demand basis, such that the code from AMCP 148 is not downloaded until runtime or otherwise immediately needed by computer 102. Note further that, in one embodiment of the present disclosure, software deploying server 150 performs all of the functions associated with the present disclosure (including execution of AMCP 148), thus freeing computer 102 from having to use its own internal computing resources to execute AMCP 148.

Also stored in system memory 136 is a VHDL (VHSIC hardware description language) program 139. VHDL is an exemplary design-entry language for field programmable gate arrays (FPGAs), application specific integrated circuits (ASICs), and other similar electronic devices. In one embodiment, execution of instructions from AMCP 148 causes VHDL program 139 to configure VHDL chip 137, which may be an FPGA, ASIC, etc.

In another embodiment of the present disclosure, execution of instructions from AMCP 148 results in a utilization of VHDL program 139 to program a VHDL emulation chip 151. VHDL emulation chip 151 may incorporate a similar architecture as described above for VHDL chip 137. Once AMCP 148 and VHDL program 139 program VHDL emulation chip 151, VHDL emulation chip 151 performs, as hardware, some or all functions described by one or more executions of some or all of the instructions found in AMCP 148. That is, the VHDL emulation chip 151 is a hardware emulation of some or all of the software instructions found in AMCP 148. In one embodiment, VHDL emulation chip 151 is a programmable read only memory (PROM) that, once burned in accordance with instructions from AMCP 148 and VHDL program 139, is permanently transformed into a new circuitry that performs the functions needed to perform the process described below in FIGS. 2-4.

The hardware elements depicted in computer 102 are not intended to be exhaustive, but rather are representative to highlight essential components required by the present disclosure. For instance, computer 102 may include alternate memory storage devices such as magnetic cassettes, digital versatile disks (DVDs), Bernoulli cartridges, and the like. These and other variations are intended to be within the spirit and scope of the present disclosure.

For purposes of the present disclosure, the term “artistic media” is defined as any file that contains an artistic work, such as a music file, a video clip, a recitation of poetry, etc. That is, the term “artistic media” is used to describe data that is non-functional for a computer (e.g., software code), but rather is media made up of files designed to be listened to, viewed, and otherwise experienced by a user for his entertainment, education, etc. The term “analytics resources” is defined as user-entered text that describes such an artistic work. This user-entered text is not ID3 or other artist-established metadata about the artistic work, nor is it a mere lookup table, etc., but rather is secondary commentary about the artistic work (e.g., interviews with or commentary by the artist, fans, etc.; descriptions of how a particular piece of artistic work relates to an event, topic, holiday, etc.). The term “playlist” is defined as a collection of artistic media. Note that while examples described below are for a playlist of songs, it is understood that such a playlist, and the media that populates it, may be any artistic media as defined above.

With reference now to FIG. 2, depicted is an exemplary network 200 in which the present disclosure may function. Coupled to network 200 are multiple entities. Note that one or more of these entities may actually be within a single entity. For example, correlation logic 206 and/or artistic media collection server 204 may both be contained within user computer 202; correlation logic 206 may be part of artistic media collection server 204; all depicted elements 202-208 may be part of a single computer system, etc. For ease of description and clarity, however, elements 202-208 will be described separately, although they may be combined, communicate directly with one another (with or without the intervention of a network 200), etc.

Assume that a user of user computer 202 (e.g., computer 102 shown in FIG. 1) desires a playlist that is made up of songs related to a particular holiday, such as Independence Day. Also assume that the user has access to a collection of songs from an artistic media collection server 204, which may be a subscription service to thousands of available songs. Alternatively, artistic media collection server 204 may be a local secondary storage device (e.g., hard drive 134 shown in FIG. 1), associated with user computer 202, which stores a local library of songs. A correlation logic 206 (e.g., AMCP 148 shown in FIG. 1) is able to correlate songs, from the collection of songs found in artistic media collection server 204, using text data found in an analytics resources server 208, which contains and supplies the analytics resources that are defined above. Using these analytics resources, correlation logic 206 is able to search a text data server 210 for user-entered text data that describes entries from the artistic media collection server 204.

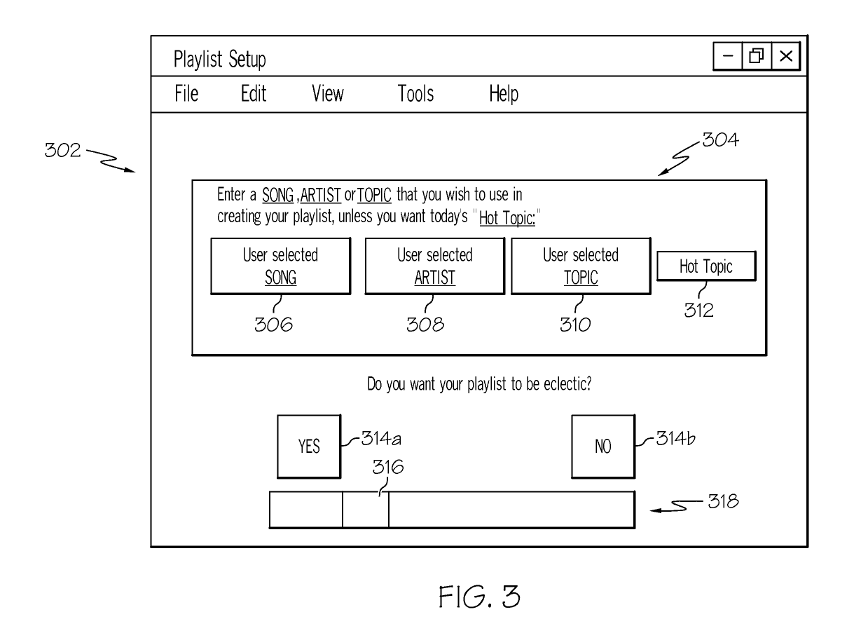

Referring now to FIG. 3, an exemplary user interface (UI) 302 for use by a user to set up a playlist is presented. As shown in block 304, the user is presented with several options as to how his playlist is “seeded” and created. That is, assume that a first song is to be added to start the playlist. This song can be selected by the user by entering the name of this song in block 306. Alternatively, the user can select an artist in block 308 or a topic (e.g., “nature”) in block 310, allowing the AMCP 148 to select any appropriate song from an available collection of songs. Alternatively, by clicking button 312, the user may elect to hear “Hot Topic” songs, which are identified by searching the Internet for the most active topics being entered that day, week, etc. For example, if there are more new entries during a predefined time period for “political election” than any other topic, then correlation AMCP 148 (i.e., correlation logic 206) will locate songs related to political elections by searching websites for songs that reference the topic “political elections.”

Once the user has determined what type of playlist he wants, he can then decide how eclectic or non-eclectic he wants the playlist to be by clicking the appropriate button 314a or 314b, or by moving a slider bar 316 in a slider window 318. In one embodiment, making a playlist eclectic or non-eclectic is accomplished by setting a first predefined number of common features shared by the first and second media files to define a high degree of correlation. A second predefined number of common features shared by the first and second media files is set to define a low degree of correlation, wherein the first predefined number is higher than the second predefined number. If the user chooses to listen to a uniform playlist made up of similar types of music (by clicking button 314b or by sliding the slider bar 316 to the right), then media files that have a high degree of correlation among themselves are added to the playlist. However, if the user chooses to listen to an eclectic playlist made up of different types of music (by clicking button 314a or by sliding the slider bar 316 to the left), then media files that have a low degree of correlation among themselves are added to the playlist. In one embodiment, this level of eclecticism can be further modified by defining songs in the playlist according to whether they have vocals or are only instrumental, the genre of the songs, the time period in which the song was recorded/released, etc.

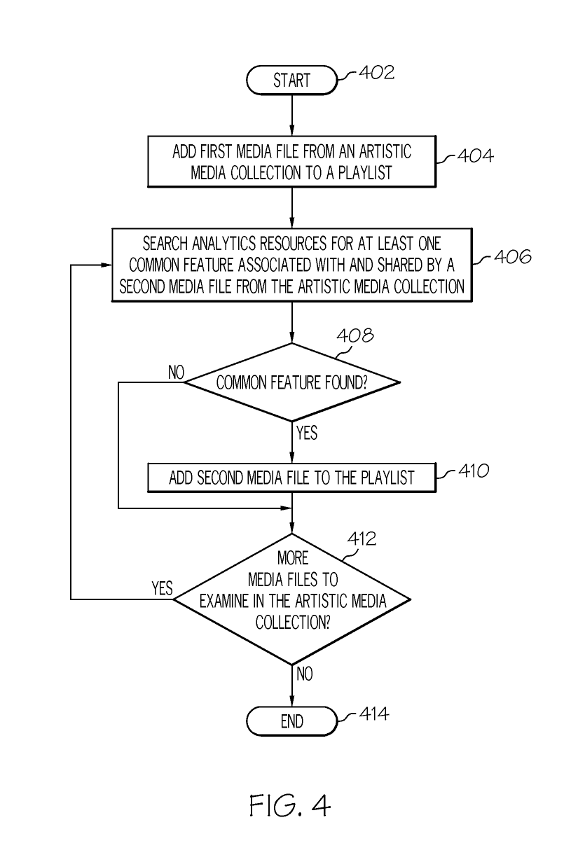

With reference now to FIG. 4, a high-level flow-chart of one or more exemplary steps processed by a computer to dynamically create a playlist of media files based on commonality factors derived from analytics resources is presented. After initiator block 402, which may be prompted by a user viewing UI 302 shown in FIG. 3, a first media file is added to a playlist, wherein the first media file is from an artistic media collection, and wherein the first media file has at least one feature described by first text data (block 404). In one embodiment, the first media file is selected by a user of the playlist (e.g., by entering a song title into block 306 shown in FIG. 3). In another embodiment, the first media file is based on an artist's name selected by a user (e.g., by entering an artist's name in block 308 shown in FIG. 3). In another embodiment, the first media file is based on a topic selected by a user (e.g., by entering a topic name in block 310 shown in FIG. 3). In another embodiment, the first media file is based on a most popular topic from a cloud of websites, wherein the most popular topic is identified as a topic that currently has a highest number of new entries on the cloud of websites (e.g., by clicking button 312 shown in FIG. 3). By clicking button 312, the user is instructing AMCP 148 (shown in FIG. 1) to search webpages and websites on the Internet for a most popular subject of the day/week/month/etc. For example, if there are more new entries on webpages for “ecology” related topics, then AMCP 148 searches those identified webpages (which have the work “ecology” recently entered) and/or all other webpages to identify any songs on the user's available song collection that are also on the webpage. For example, a webpage may have both the words “ecology” and “Song Title A” entered on that webpage. AMCP 148 and/or correlation logic 206 then correlates the topic “ecology” with the song titled “Song Title A”. Thus, “ecology” is the feature that describes the song titled as “Song Title A.”

With reference to block 406, a processor searches an analytics resource for at least one common feature associated with and shared by the first media file and a second media file from the artistic media collection, wherein the at least one common feature is identified by matching the first text data with second text data in the analytics resource, and wherein the second text data in the analytics resource is a user entry about the second media file. To continue with the example above, the first song (e.g., “Song Title A”) has a first text data “ecology.” AMCP 148 and/or correlation logic 206 then searches the Internet for webpages that refer to a second song (e.g., with a title of “Song Title B”) as well as “ecology.” AMCP and/or correlation logic 206 then determine that “Song Title A” and “Song Title B” are both about ecology (query block 408), and the second media file (e.g., the song titled “Song Title B”) will be added to the playlist (block 410). The process continues (query block 412) until no more media files from the available artistic media collection are available or need to be examined (e.g., a maximum number of songs in the playlist has been reached). The process ends at terminator block 414.

Note that while the process described in FIG. 4 demonstrates adding media files in real time, in another embodiment these media files can be defined and/or added to the playlist earlier. For example, the correlation logic 206 shown in FIG. 2 can be running in the background, or even before being requested, or even before the user logs in to the system, and continuously examining entries supplied by the text data server 210 in order to correlate and/or aggregate related media files from the artistic media collection server 204. By having such pre-aggregated lists, the system shown in FIG. 2 is able to supply the aggregated related media files as soon as the seed topic is identified. As described herein, this seed topic may be supplied by the user (e.g., the user selected song/artist/topic), by a topic selected by another (e.g., the hot topic), or even randomly or filtered-randomly. For example, to filtered-randomly select a topic, a logic (e.g., AMCP 148 shown in FIG. 1) may examine a profile for a user. Based on this profile, one or multiple topics that may appeal to that user can be selected as the seed topic, from which the aggregated related media files are defined.

In one embodiment, an overlay may be made on the playlist, in order to ensure further harmony between songs. For example, new additions to the playlist may be limited to media files (songs) that have a common metadata in their respective ID3 tags, by a music genre, artist, etc. selected by the user, etc.

In one embodiment, the analytics resource described above may be a wiki webpage, wherein the wiki webpage is from a collaborative website that comprises entries from multiple users, and wherein the wiki webpage comprises a user entry that describes one or more artists that have works in the artistic media collection. This wiki webpage may include encyclopedic-type entries, blog entries, discussion boards, etc. For example, a blogger may type in “Song Title B is a great song about our ecology,” which would result in Song Title B being added to the ecology-based playlist of the example above.

In one embodiment, the analytics resource described above may be a blogsite, a semi-commercial user website, or any other website in which users and/or a commercial vendor supplies text data that is descriptive of how a particular song is being played, used, analyzed, reported, etc.

In one embodiment, the analytics resource described above may be a news webpage, wherein the news webpage is supported by a news enterprise, and wherein the news webpage comprises a news article about one or more artists that have works in the artistic media collection. For example, a new service may report that “Song Title B was performed at an ecology rally today,” which would result in Song Title B being added to the ecology-based playlist of the example above.

In one embodiment, the correlation logic 206 and the user computer 202 are within a same component, such as an MP3 player. Thus, the user can select a seed topic on her MP3 player (user computer 202), and correlation logic 206 will then locate the requisite aggregated playlist of related songs. In order to efficiently accomplish this, metadata derived by the analytics resources server 208 is transferred to the MP3 player, thus enabling the MP3 player to quickly retrieve the aggregated playlist of related songs. In one embodiment, this metadata and the associated aggregated playlist can be created by a third party (not shown in the figures), which can provide such resources to a user on a subscription basis.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the invention of the present application in detail and by reference to illustrative embodiments thereof, it will be apparent that modifications and variations are possible without departing from the scope of the invention defined in the appended claims.

What is claimed is:

1. A computer-implemented method of generating a playlist, the computer-implemented method comprising:
adding a first media file to a playlist, wherein the first media file is from an artistic media collection, and wherein the first media file has at least one feature described by first text data;
a processor searching an analytics resource for at least one common feature associated with and shared by the first media file and a second media file from the artistic media collection, wherein the at least one common feature is identified by matching the first text data with second text data in the analytics resource, and wherein the second text data in the analytics resource is a user entry about the second media file; and
in response to at least one common feature being identified for the first and second media files, adding the second media file to the playlist.

2. The computer-implemented method of claim 1, further comprising:
limiting an addition of additional media files to the playlist to media files that have a common metadata in their respective ID3 tags.

3. The computer-implemented method of claim 1, wherein the media files are accessed by a subscription to a central repository of artistic media files.

4. The computer-implemented method of claim 1, wherein the media files are multimedia files.

5. The computer-implemented method of claim 1, wherein the media files are audio files.

6. The computer-implemented method of claim 5, further comprising:
setting a first predefined number of common features shared by the first and second media files to define a high degree of correlation;
setting a second predefined number of common features shared by the first and second media files to define a low degree of correlation, wherein the first predefined number is higher than the second predefined number;
in response to a user choosing to listen to a uniform playlist made up of similar types of music, placing media files that have a high degree of correlation among themselves in the playlist; and
in response to a user choosing to listen to an eclectic playlist made up of different types of music, placing media files that have a low degree of correlation among themselves in the playlist.

7. The computer-implemented method of claim 1, wherein the analytics resource is a wild webpage, wherein the wiki webpage is from a collaborative website that comprises entries from multiple users, and wherein the wiki webpage comprises a user entry that describes one or more artists that have works in the artistic media collection.

8. The computer-implemented method of claim 1, wherein the analytics resource is a news webpage, wherein the news webpage is supported by a news enterprise, and wherein the news webpage comprises a news article about one or more artists that have works in the artistic media collection.

9. The computer-implemented method of claim 1, wherein the first media file is selected by a user of the playlist.

10. The computer-implemented method of claim 1, wherein the first media file is based on a topic selected by a user.

11. The computer-implemented method of claim 1, wherein the first media file is based on a most popular topic from a cloud of websites, wherein the most popular topic is identified as a topic that currently has a highest number of new entries on the cloud of websites.

12. The computer-implemented method of claim 1, wherein the playlist is created before being requested by a user.

13. The computer-implemented method of claim 1, wherein the user entry is randomly generated by a computer.

14. The computer-implemented method of claim 1, wherein the user entry is generated by a computer based on a profile of a user of the playlist.

15. The computer-implemented method of claim 1, wherein said adding a first media file to a playlist, said searching an analytics resource for at least one common feature associated with and shared by the first media file and a second media file from the artistic media collection, and said adding the second media file to the playlist are performed by a local media player using metadata, for the first and second media files, that has been generated by a subscription-based third party.

16. A computer program product comprising:
a computer readable storage media;
first program instructions to add a first media file to a playlist, wherein the first media file is from an artistic media collection, and wherein the first media file has at least one feature described by first text data;
second program instructions to search an analytics resource for at least one common feature associated with and shared by the first media file and a second media file from the artistic media collection, wherein the at least one common feature is identified by matching the first text data with second text data in the analytics resource, and wherein the second text data in the analytics resource is a user entry about the second media file; and
third program instructions to, in response to at least one common feature being identified for the first and second media files, add the second media file to the playlist; and wherein
said first, second and third program instructions are stored on said computer readable storage media.

17. The computer program product of claim 16, wherein the analytics resource is a wild webpage, wherein the wiki webpage is from a collaborative website that comprises entries from multiple users, and wherein the wiki webpage comprises a user entry about one or more artists that have works in the artistic media collection.

18. A system comprising:
a processor coupled to a memory, wherein the processor is programmed to:
add a first media file to a playlist, wherein the first media file is from an artistic media collection, and wherein the first media file has at least one feature described by first text data;
search an analytics resource for at least one common feature associated with and shared by the first media file and a second media file from the artistic media collection, wherein the at least one common feature is identified by matching the first text data with second text data in the analytics resource, and wherein the second text data in the analytics resource is a user entry about the second media file; and
in response to at least one common feature being identified for the first and second media files, add the second media file to the playlist.

19. The system of claim 18, wherein the processor is further programmed to:
limit the addition of additional media files to the playlist to artistic media files that have a common metadata in their respective ID3 tags.

20. The system of claim 18, wherein the artistic media files are accessed by a subscription to a central repository of artistic media files.
